(19) United States
(12) Patent Application Publication
(10) Pub. No.: US 2019/0260643 A1
(43) Pub. Date: Aug. 22, 2019

(54) INFORMATION PROCESSING APPARATUS AND INFORMATION PROCESSING METHOD

(71) Applicant: FUJITSU LIMITED, Kawasaki-shi (JP)

(72) Inventors: Hiroya Mori, Kawasaki (JP); Yusuke Hara, Yokohama (JP); Fumiya Okada, Kawasaki (JP); Yosuke Kobayashi, Kawasaki (JP)

(73) Assignee: FUJITSU LIMITED, Kawasaki-shi (JP)

(21) Appl. No.: 16/276,791

(22) Filed: Feb. 15, 2019

(30) Foreign Application Priority Data
Feb. 19, 2018 (JP) 2018-027406

(51) Int. Cl. H04L 12/24; H04L 12/26; H04L 12/865

(52) U.S. Cl. CPC H04L 41/0896; H04L 41/147; H04L 47/6275; H04L 43/0894

(57) ABSTRACT

An information processing apparatus includes a memory and a processor coupled to the memory. The processor is configured to determine whether a first physical host of a plurality of physical hosts is able to transmit logs based on a first bandwidth of a management local area network via which the plurality of physical hosts transmit logs, a second bandwidth of the management local area network used when the first physical host transmits logs, and a third bandwidth of the management local area network used when a controller controls an information processing system including the plurality of physical hosts. The processor is configured to transmit, to the first physical host, an instruction to transmit logs when it is determined that the first physical host is able to transmit logs.

### CROSS-REFERENCE TO RELATED APPLICATION

This application is based upon and claims the benefit of priority of the prior Japanese Patent Application No. 2018-27406, filed on Feb. 19, 2018, the entire contents of which are incorporated herein by reference.

### FIELD

The embodiments discussed herein are related to an information processing apparatus and an information processing method.

### BACKGROUND

There is a log server that collects logs of plural physical hosts through a network and displays logs in accordance with a request of a user. Here, the physical host is a computer that executes information processing. FIG. 25 is a diagram for explaining log aggregation to a log server. FIG. 25 illustrates part of a cluster system. In FIG. 25, physical host #1 to physical host #3 are physical hosts 1. A log server 92 is an information processing apparatus that collects logs from physical host #1 to physical host #3 to save the logs in a storing apparatus periodically (for example, every hour), and displays logs in accordance with a request for log disclosure from a user.

However, when the respective physical hosts 1 transfer logs at the same time, possibly congestion occurs in the network. For this reason, the log server 92 carries out scheduling of the physical hosts 1 that transfer logs based on a log holding amount, a log output predicted amount, and a log non-transfer period, for example. FIG. 26 is a diagram illustrating a log holding amount and the log output predicted amount. In FIG. 26, regions filled with horizontal lines represent the log holding amount that is the amount of logs held by the physical host 1 at a clock time t₁ and regions filled with vertical lines represent the log output predicted amount that is the amount of logs expected to be output by the physical host 1 from t₁ to t₂. t₂−t₁=T is a log collection interval. In FIG. 26, physical host #1 has the largest sum of the log holding amount and the log output predicted amount at t₁. Therefore, when there is no difference in the log non-transfer period, the log server 92 instructs physical host #1 to transfer logs at t₁.

As a related technique, there is a technique in which concentration of log collection is avoided by scheduling a timing when equipment with the highest communication load of log transfer transmits log data into a time zone in which a communication band that may be used for receiving the log data from the equipment exists.

Furthermore, as a related technique, there is a monitoring data transfer system that allows efficient collection of monitoring data managed in a distributed manner in each of plural cloud systems connected with a network. This monitoring data transfer system includes a communication apparatus that communicates with a monitoring apparatus in each of plural domains, a storing apparatus that stores a first table in which the kinds of monitoring data managed by the monitoring apparatuses of the respective domains are described, and an arithmetic apparatus that executes the following first processing and second processing. As the first processing, the arithmetic apparatus identifies, based on the first table, the monitoring apparatus of an analysis-target domain that manages the kind of monitoring data as the analysis target in given analysis processing. As the second processing, the arithmetic apparatus acquires attribute information of the monitoring data of the analysis target from the identified monitoring apparatus of the analysis-target domain and applies this attribute information to a given algorithm. Moreover, as the second processing, the arithmetic apparatus decides an execution domain of the analysis processing and the transfer path of the monitoring data of the analysis target between this execution domain of the analysis processing and the analysis-target domain other than the execution domain that offer the best efficiency of monitoring data transfer between the analysis-target domains.

In addition, as a related technique, there is a communication method with which control of the degree of priority is possible in a communication system that transfers messages among plural computers. In this communication method, the computers include at least one of a message transmitting unit and a message receiving unit and at least one or more computers include a message control unit and a message management unit. The message management unit acquires at least either the load of the computer including the message control unit or the transmission amount of messages transmitted from the respective message transmitting units or the number of transmitted messages, and acquires priority setting for controlling the degree of priority in transferring each message. Then, based on the acquired priority setting and the load of the computer or the transmission amount of messages, the message management unit decides the capacity of messages that may be transmitted by each message transmitting unit and transmits the decided capacity of messages to each message transmitting unit. Then, each message transmitting unit controls the transmission amount of messages based on the received capacity of messages.

Related techniques are disclosed in, for example, Japanese Laid-open Patent Publication No. 2016-110280, Japanese Laid-open Patent Publication No. 2015-109609, and Japanese Laid-open Patent Publication No. 2011-182115.

The network used for log transfer is also used for control of the cluster system. Therefore, there is a problem that the control of the cluster system is adversely affected if the bandwidth of the network used for log transfer is so large that congestion is about to occur. FIG. 27 is a diagram for explaining a problem of log collection of a related technique.

In FIG. 27, a controller 3 controls a cloud system. For example, when a virtual router operates on the physical host 1 and a firewall is set, the controller 3 controls the physical host 1 by updating the rule of the firewall. If the bandwidth of the network used for log transfer is so large that congestion is about to occur, the updating of the rule of the firewall is delayed.

### SUMMARY

According to an aspect of the present invention, provided is an information processing apparatus including a memory and a processor coupled to the memory. The processor is configured to determine whether a first physical host of a plurality of physical hosts is able to transmit logs based on a first bandwidth of a management local area network via which the plurality of physical hosts transmit logs, a second bandwidth of the management local area network used when the first physical host transmits logs, and a third bandwidth of the management local area network used when a controller controls an information processing system including the plurality of physical hosts. The processor is configured to transmit, to the first physical host, an instruction to transmit logs when it is determined that the first physical host is able to transmit logs.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining log collection by a log server according to embodiment 1;

FIG. 2 is a diagram illustrating a functional configuration of a log server;

FIG. 3 is a diagram illustrating one example of a used bandwidth storing unit;

FIG. 4 is a diagram illustrating one example of a physical host storing unit;

FIG. 5 is a diagram illustrating one example of a log transfer list;

FIG. 6 is a diagram illustrating one example of bandwidth information between each physical host and a log server;

FIG. 7 is a flowchart illustrating a flow of processing by a log server;

FIG. 8 is a flowchart illustrating a flow of processing of calculating an expected required bandwidth;

FIG. 9 is a flowchart illustrating a flow of processing of calculating an expected used control bandwidth;

FIG. 10 is a flowchart illustrating a flow of processing of storing a log non-transfer period, a log holding amount, and a log output predicted amount;

FIG. 11 is a flowchart illustrating a flow of processing of calculating a log transfer bandwidth;

FIG. 12 is a flowchart illustrating a flow of processing of creating a log transfer list;

FIG. 13 is a flowchart illustrating a flow of processing of deciding a physical host that is to transfer logs;

FIG. 14 is a flowchart illustrating a flow of processing by a log server according to embodiment 2;

FIG. 15 is a diagram illustrating a log transfer list after a leading element is deleted from a log transfer list illustrated in FIG. 5;

FIG. 16 is a flowchart illustrating a flow of processing by a log server according to embodiment 3;

FIG. 17 is a diagram illustrating an example of a used bandwidth storing unit;

FIG. 18 is a diagram illustrating an example of a log transfer list;

FIG. 19 is a diagram illustrating an example of bandwidth information between each physical host and a log server;

FIG. 20 is a diagram illustrating bandwidth information between each physical host and a log server after a used bandwidth when a physical host #1 transfers logs is added;

FIG. 21 is a diagram illustrating a log transfer list after a leading element is deleted from a log transfer list illustrated in FIG. 18;

FIG. 22 is a diagram illustrating bandwidth information between each physical host and a log server after a used bandwidth when a physical host #4 transfers logs is added;

FIGS. 23A to 23C depict diagrams illustrating a log transfer list after a leading element is sequentially deleted from a log transfer list illustrated in FIG. 21;

FIG. 24 is a diagram illustrating a hardware configuration of a log server that executes a program according to an embodiment;

FIG. 25 is a diagram for explaining log aggregation to a log server;

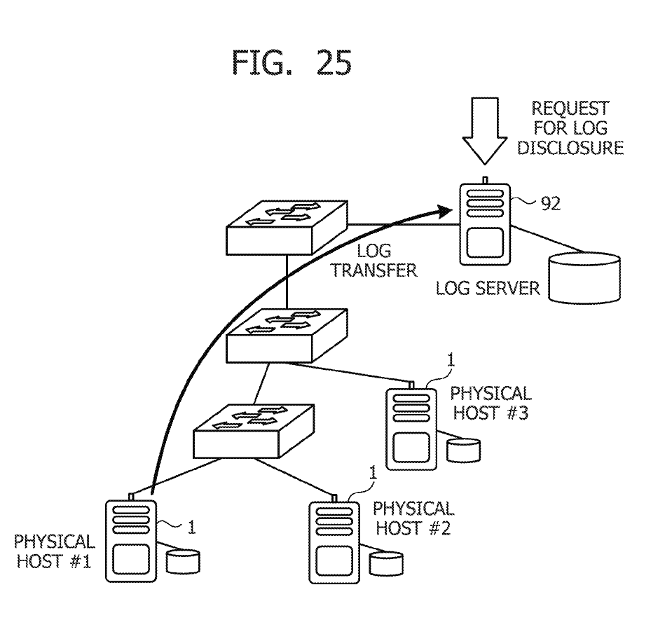

FIG. 26 is a diagram illustrating a log holding amount and a log output predicted amount; and

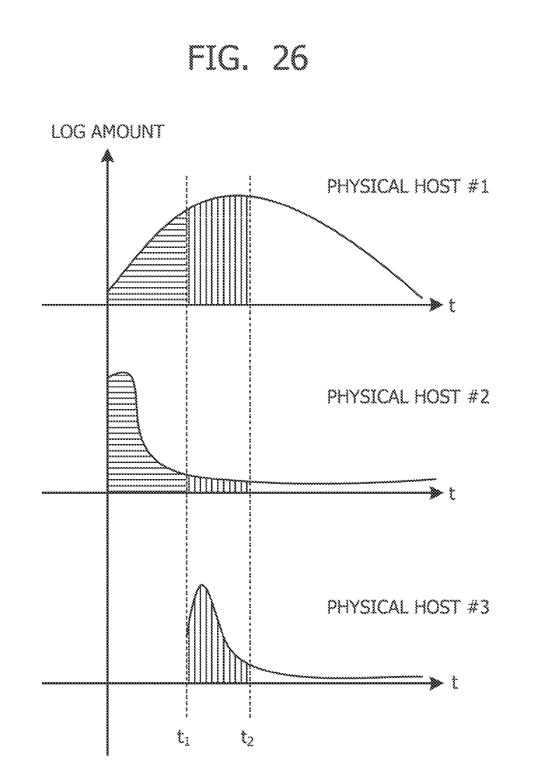

FIG. 27 is a diagram for explaining a problem of log collection of a related technique.

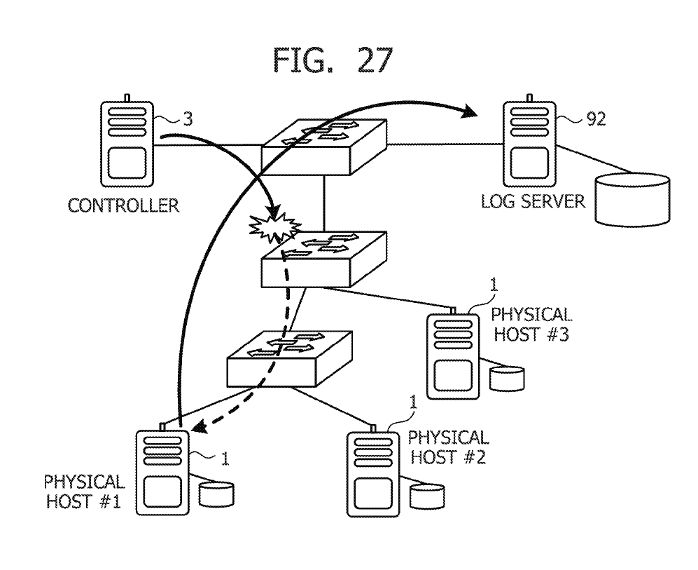

### DESCRIPTION OF EMBODIMENTS

Embodiments disclosed by the present application will be described in detail below based on the drawings. These embodiments do not limit techniques of the disclosure.

### Embodiment 1

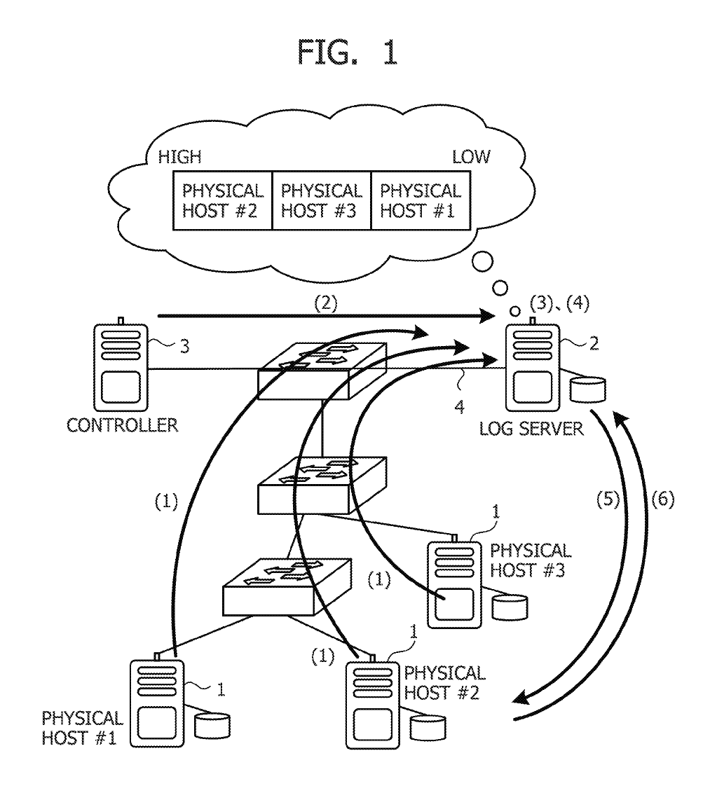

First, log collection by a log server according to embodiment 1 will be described. FIG. 1 is a diagram for explaining log collection by a log server according to embodiment 1. FIG. 1 illustrates part of a cluster system. In FIG. 1, physical hosts 1 represented by physical host #1 to physical host #3 are computers that execute information processing. A virtual router operates on each physical host 1 and a firewall is set thereon.

A log server 2 collects logs from physical host #1 to physical host #3 to save the logs in a storing apparatus periodically (for example, every hour), and displays logs in accordance with a request for log disclosure from a user. A controller 3 controls the cluster system. For example, the controller 3 updates the rule of the firewall.

The log server 2 is an information processing apparatus that collects logs from physical host #1 to physical host #3 by using a management local area network (LAN) 4. The management LAN 4 is a LAN used for control of a cloud system and is used for communication by which the controller 3 instructs the physical host 1 to create a virtual router, for example. A different LAN from the management LAN 4 is used for communication between the physical hosts 1, for example communication from a virtual router on physical host #1 to a virtual router on physical host #2.

The log server 2 carries out scheduling of log transfer based on the bandwidth used in the management LAN 4 for the control of the cloud system besides the log holding amount, the log output predicted amount, and the log non-transfer period. As the bandwidth used in the management LAN 4 for the control of the cloud system, there are the bandwidth used in regularly-executed processing and the bandwidth used in irregularly-executed processing. In the following description, the case in which description is made simply as “bandwidth” represents the bandwidth in the management LAN 4.

As the regularly-executed processing, there is regular monitoring of the respective services offered by the cloud system. The bandwidth used in the regularly-executed processing may be identified from the design of the cloud system and the log server 2 stores a value identified from the design of the cloud system.

As the irregularly-executed processing, there are processing that occurs due to user requests, processing that occurs in maintenance work, and restoration processing at the time of failure. The bandwidth used in the processing that occurs due to user requests may be predicted from the use status of the bandwidth of the past user requests and the log server 2 predicts a value from the use status of the bandwidth of the past user requests. For example, the log server 2 predicts the used bandwidth of the current day based on the communication amount of user requests of past two days. The controller 3 holds the communication amount of past user requests.

The bandwidth used in the processing that occurs in maintenance work may be identified from a maintenance work plan of an operator of the cloud system and the log server 2 stores a value identified from the maintenance work plan. The bandwidth used in the restoration processing at the time of failure is difficult to identify because the failure suddenly occurs. For this reason, the log server 2 stores a value ensured as a bandwidth for the restoration processing.

As illustrated in FIG. 1, each physical host 1 transmits the log non-transfer period (D=log collection interval T×n, n is an integer equal to or larger than 0), the log holding amount (L), and the log output predicted amount (P) to the log server 2 (1). Furthermore, the controller 3 transmits the communication amount of past user requests to the log server 2 (2). The log server 2 calculates the degree of priority of each physical host 1 in log transfer based on the log non-transfer period, the log holding amount, and the log output predicted amount and lists the physical hosts 1 in order of degree of priority (3). The log server 2 calculates the degree of priority of each physical host 1 in log transfer by using (L+P)×D, for example. In FIG. 1, the physical hosts 1 are listed in order of physical host #2, physical host #3, and physical host #1.

Then, the log server 2 calculates an expected used control bandwidth based on the bandwidth used in the regularly-executed processing and the bandwidth used in the irregularly-executed processing and determines whether log transfer bandwidth+expected used control bandwidth regarding the highest degree of priority is equal to or larger than the bandwidth of the management LAN 4 (4). Here, the expected used control bandwidth is the bandwidth expected to be used for the control of the cloud system. Then, when log transfer bandwidth+expected used control bandwidth regarding the highest degree of priority is smaller than the bandwidth of the management LAN 4, the log server 2 instructs the physical host 1 with the highest degree of priority to transfer logs (5). In FIG. 1, physical host #2 is instructed to transfer logs. Then, the instructed physical host 1 transfers logs to the log server 2 (6).

As above, because the log server 2 instructs the physical host 1 with the highest degree of priority to transfer logs when log transfer bandwidth+expected used control bandwidth regarding the highest degree of priority is smaller than the bandwidth of the management LAN 4, the adverse effect of log transfer on the control of the cloud system may be suppressed.

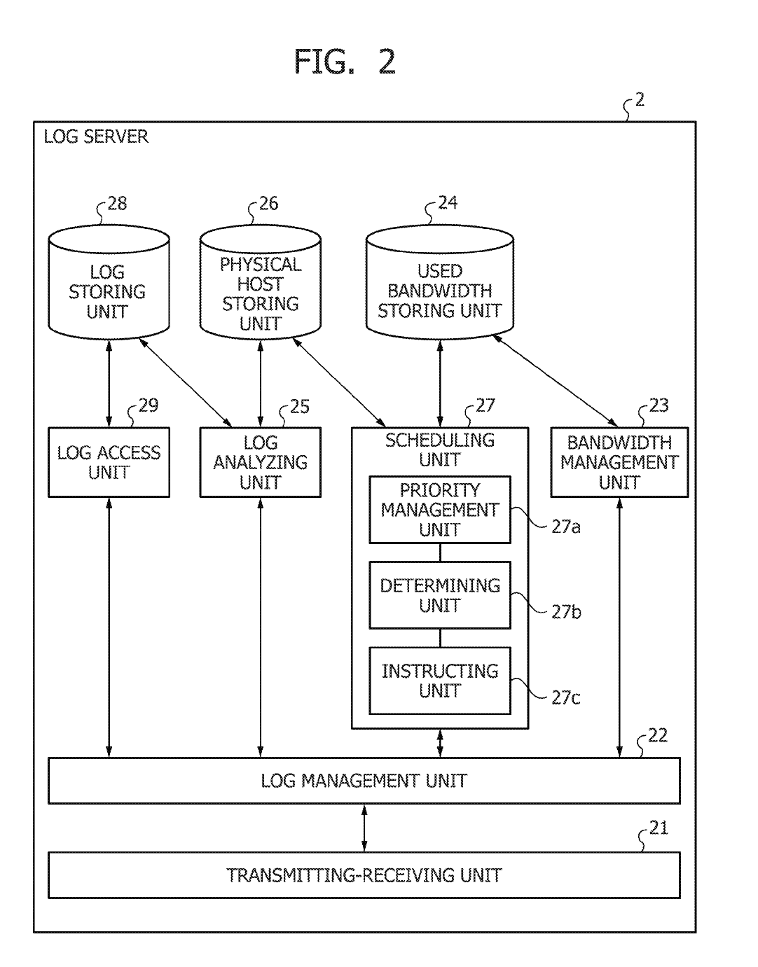

Next, the functional configuration of the log server 2 will be described. FIG. 2 is a diagram illustrating a functional configuration of a log server. As illustrated in FIG. 2, a log server 2 includes a transmitting-receiving unit 21, a log management unit 22, a bandwidth management unit 23, a used bandwidth storing unit 24, a log analyzing unit 25, a physical host storing unit 26, a scheduling unit 27, a log storing unit 28, and a log access unit 29.

The transmitting-receiving unit 21 carries out communication with the physical hosts 1 and the controller 3 through the management LAN 4. For example, the transmitting-receiving unit 21 receives the log non-transfer period, the log holding amount, and the log output predicted amount from each physical host 1. Furthermore, the transmitting-receiving unit 21 transmits an instruction to transfer logs to the physical host 1. Moreover, the transmitting-receiving unit 21 receives logs from the physical host 1. In addition, the transmitting-receiving unit 21 receives the communication amount of past user requests from the controller 3.

The log management unit 22 manages the log server 2 and causes the log server 2 to function as a log management apparatus by carrying out movement of control between functional units, data passing between functional units, and so forth. For example, the log management unit 22 receives the log non-transfer period, the log holding amount, and the log output predicted amount from the transmitting-receiving unit 21 and passes them to the log analyzing unit 25. Furthermore, the log management unit 22 receives a log transfer instruction from the scheduling unit 27 and passes it to the transmitting-receiving unit 21. Moreover, the log management unit 22 receives logs from the transmitting-receiving unit 21 and passes them to the log access unit 29. In addition, the log management unit 22 receives the communication amount of past user requests from the transmitting-receiving unit 21 and passes it to the bandwidth management unit 23. Furthermore, the log management unit 22 passes a request for log display from a user to the log analyzing unit 25.

The bandwidth management unit 23 stores the communication amount of past user requests in the used bandwidth storing unit 24. Furthermore, the bandwidth management unit 23 calculates the communication amount of user requests and a required bandwidth expected from the communication amount of past user requests and stores them in the used bandwidth storing unit 24. Moreover, the bandwidth management unit 23 calculates the expected used control bandwidth by adding the required bandwidth of the user requests expected, the bandwidth for regular monitoring, the bandwidth for maintenance work, and the bandwidth for restoration at the time of failure, and stores the expected used control bandwidth in the used bandwidth storing unit 24.

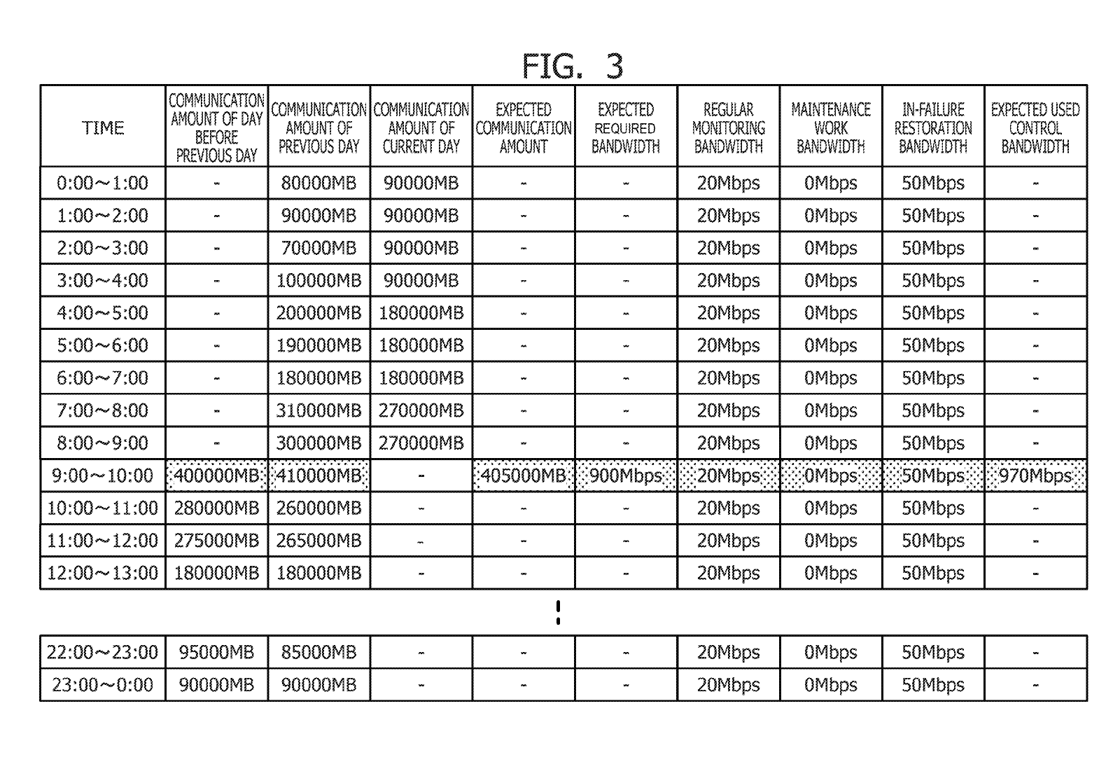

The used bandwidth storing unit 24 stores the expected used control bandwidth and information used for calculation of the expected used control bandwidth. FIG. 3 is a diagram illustrating one example of a used bandwidth storing unit. As illustrated in FIG. 3, a used bandwidth storing unit 24 stores, every hour, the communication amount of the day before the previous day, the communication amount of the previous day, the communication amount of the current day, an expected communication amount, the expected required bandwidth, a regular monitoring bandwidth, a maintenance work bandwidth, an in-failure restoration bandwidth, and the expected used control bandwidth.

The communication amount of the day before the previous day is the amount of communication caused in processing of user requests on the day before the previous day. The communication amount of the previous day is the amount of communication caused in processing of user requests on the previous day. The communication amount of the current day is the amount of communication caused in processing of user requests on the current day. FIG. 3 represents the used bandwidth storing unit 24 as of nine o'clock. In FIG. 3, the used bandwidth storing unit 24 stores data of two days as data of every hour regarding the amount of communication caused in processing of user requests.

The expected communication amount is the amount of communication expected to be caused in processing of user requests and is calculated based on the communication amounts of the day before the previous day and the previous day. The expected required bandwidth is a value obtained by converting the expected communication amount in terms of the bandwidth. The regular monitoring bandwidth is the bandwidth used for processing caused in the regular monitoring. The maintenance work bandwidth is the bandwidth used for processing caused in the maintenance work. The in-failure restoration bandwidth is the bandwidth used for the restoration processing at the time of failure.

For example, as of nine o'clock, the amount of communication caused in processing of user requests on the day before the previous day is 400000 megabytes (MB) and the amount of communication caused in processing of user requests on the previous day is 410000 MB. The amount of communication expected to be caused in processing of user requests is the average between the day before the previous day and the previous day and is 405000 MB. The expected required bandwidth is 405000 MB×8/3600=900 megabits per second (Mbps). The expected used control bandwidth is 900 Mbps+20 Mbps+0 Mbps+50 Mbps=970 Mbps.

The log analyzing unit 25 receives the log non-transfer period, the log holding amount, and the log output predicted amount from the log management unit 22 and stores them in the physical host storing unit 26. Furthermore, the log analyzing unit 25 calculates the log transfer bandwidth based on the sum of the log holding amount and the log output predicted amount regarding each physical host 1 and stores the log transfer bandwidth in the physical host storing unit 26. Moreover, when receiving a request for log display by a user through the log management unit 22, the log analyzing unit 25 analyzes logs and passes the analysis result to the log management unit 22.

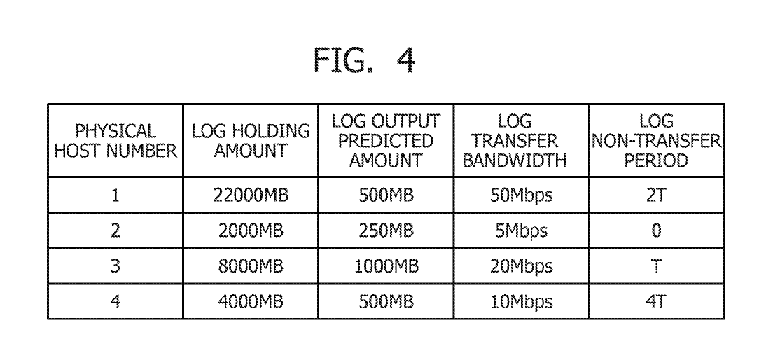

The physical host storing unit 26 stores information relating to logs of the physical hosts 1. FIG. 4 is a diagram illustrating one example of a physical host storing unit. As illustrated in FIG. 4, a physical host storing unit 26 stores a physical host number, the log holding amount, the log output predicted amount, the log transfer bandwidth, and the log non-transfer period regarding each physical host 1. The physical host number is a number to identify the physical host 1. For example, the log holding amount, the log output predicted amount, the log transfer bandwidth, and the log non-transfer period of physical host #1 are 22000 MB, 500 MB, (22000+500) MB×8/3600=50 Mbps, and 2 T, respectively.

The scheduling unit 27 identifies the physical host 1 that is to transfer logs based on the used bandwidth storing unit 24 and the physical host storing unit 26 and instructs the identified physical host 1 to transfer logs. The scheduling unit 27 includes a priority management unit 27a, a determining unit 27b, and an instructing unit 27c.

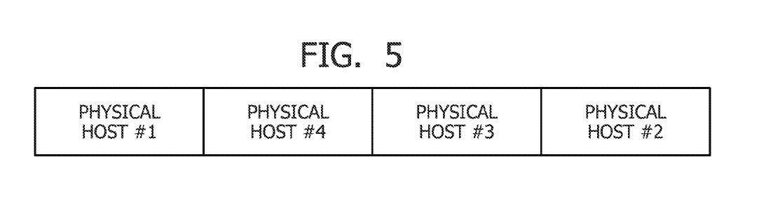

The priority management unit 27a calculates the degree of priority of the physical hosts 1 in log transfer based on the physical host storing unit 26 and creates a log transfer list in which the physical hosts 1 are listed in order of degree of priority. For example, when (L+P)×D of physical host #1 to physical host #4 is calculated based on FIG. 4, the calculation results are (22000+500)×2 T=45000 T, (2000+250)×0=0, (8000+1000)×T=9000 T, and (4000+500)×4 T=18000 T. Therefore, the degree of priority is high in order of physical host #1, physical host #4, physical host #3, and physical host #2. FIG. 5 is a diagram illustrating one example of a log transfer list. As illustrated in FIG. 5, the physical hosts 1 are listed in order of degree of priority in the log transfer list. Furthermore, the priority management unit 27a updates the log transfer list.

The determining unit 27b determines whether the sum of the log transfer bandwidth stored by the physical host storing unit 26 and the expected used control bandwidth stored by the used bandwidth storing unit 24 is equal to or larger than the bandwidth of the management LAN 4 regarding the physical host 1 with the highest degree of priority.

When it is determined in the determining unit 27b that the sum of the log transfer bandwidth and the expected used control bandwidth is not equal to or larger than the bandwidth of the management LAN 4, the instructing unit 27c instructs the physical host 1 with the highest degree of priority to transfer logs.

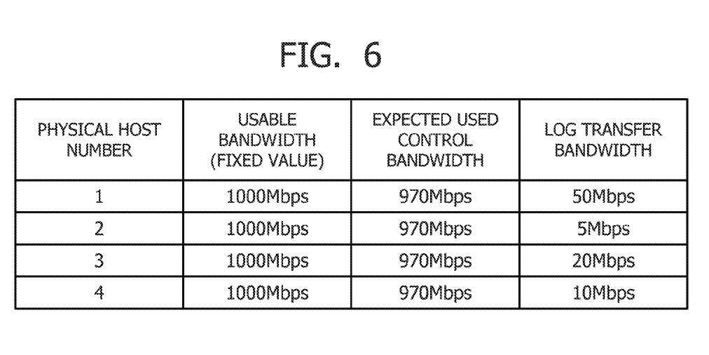

FIG. 6 is a diagram illustrating one example of bandwidth information between each physical host and a log server. In FIG. 6, the usable bandwidth is the bandwidth of the management LAN 4. Assuming that the usable bandwidth between each physical host 1 and the log server 2 is 1000 Mbps, regarding physical host #1, the sum 1020 Mbps of the log transfer bandwidth 50 Mbps and the expected used control bandwidth 970 Mbps is larger than the usable bandwidth 1000 Mbps. Therefore, at nine o'clock, the scheduling unit 27 does not make an instruction to transfer logs regarding physical host #1, which has the highest degree of priority in the log transfer list of FIG. 5.

The log storing unit 28 stores logs transmitted from the respective physical hosts 1. The log access unit 29 receives the logs of the physical hosts 1 from the log management unit 22 and stores them in the log storing unit 28.

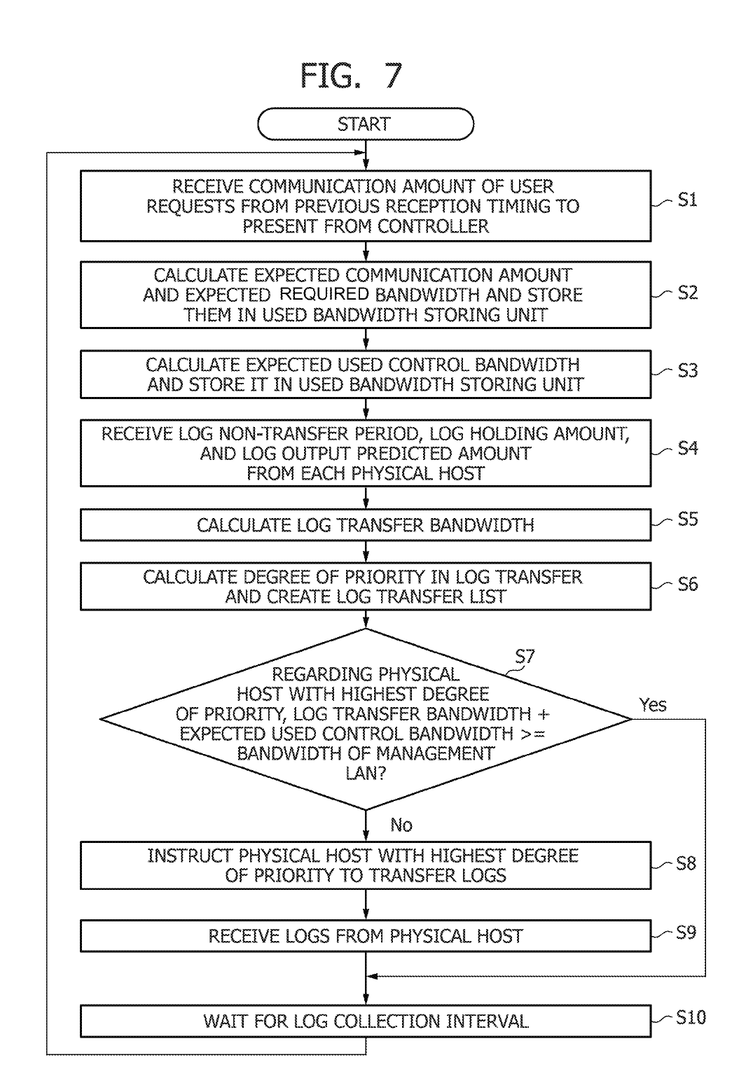

Next, the flow of processing by the log server 2 will be described. FIG. 7 is a flowchart illustrating a flow of a processing by a log server 2. As illustrated in FIG. 7, the log server 2 receives the communication amount of user requests from the previous reception timing to the present from the controller 3 and stores it in the used bandwidth storing unit 24 (step S1). For example, assuming that the log collection interval is one hour and the present clock time is nine o'clock, the log server 2 stores the received communication amount 270000 MB at a place corresponding to 8:00 to 9:00 of the communication amount of the current day in the used bandwidth storing unit 24 illustrated in FIG. 3.

Then, the log server 2 calculates the expected communication amount and the expected required bandwidth based on the communication amounts of user requests of the day before the previous day and the previous day and stores them in the used bandwidth storing unit 24 (step S2). For example, based on the communication amounts 400000 MB and 410000 MB of the day before the previous day and the previous day of 9:00 to 10:00 in the used bandwidth storing unit 24 illustrated in FIG. 3, the log server 2 calculates the expected communication amount 405000 MB and the expected required bandwidth 900 Mbps of 9:00 to 10:00.

Then, the log server 2 calculates the expected used control bandwidth and stores it in the used bandwidth storing unit 24 (step S3). For example, the log server 2 calculates expected required bandwidth 900 Mbps+regular monitoring bandwidth 20 Mbps+maintenance work bandwidth 0 Mbps+in-failure restoration bandwidth 50 Mbps of 9:00 to 10:00 in the used bandwidth storing unit 24 illustrated in FIG. 3 and stores the expected used control bandwidth 970 Mbps.

Then, the log server 2 receives the log non-transfer period, the log holding amount, and the log output predicted amount from each physical host 1 (step S4) and calculates the log transfer bandwidth of each physical host 1 (step S5). Then, the log server 2 calculates the degree of priority in log transfer based on the log non-transfer period, the log holding amount, and the log output predicted amount and creates a log transfer list (step S6).

Then, the log server 2 determines whether log transfer bandwidth+expected used control bandwidth is equal to or larger than the bandwidth of the management LAN 4 regarding the physical host 1 with the highest degree of priority (step S7), and proceeds to a step S10 when the sum is equal to or larger than the bandwidth of the management LAN 4. On the other hand, when log transfer bandwidth+expected used control bandwidth is not equal to or larger than the bandwidth of the management LAN 4, the log server 2 instructs the physical host 1 with the highest degree of priority to transfer logs (step S8) and receives logs from the instructed physical host 1 (step S9).

Then, the log server 2 waits for the log collection interval (step S10) and returns to the step S1.

As above, the log server 2 instructs the physical host 1 with the highest degree of priority to transfer logs when log transfer bandwidth+expected used control bandwidth is not equal to or larger than the bandwidth of the management LAN 4. Thus, the occurrence of congestion in the management LAN 4 due to log transfer may be suppressed.

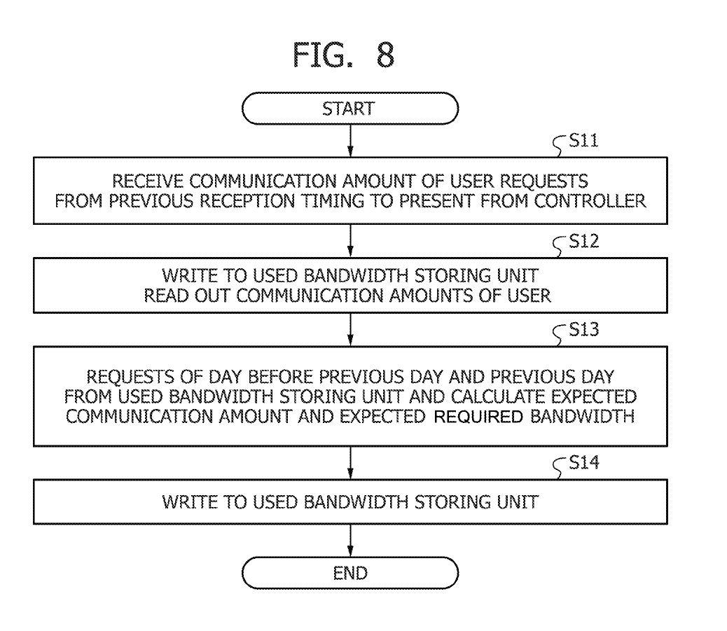

FIG. 8 is a flowchart illustrating a flow of processing of calculating an expected required bandwidth. As illustrated in FIG. 8, the bandwidth management unit 23 receives the communication amount of user requests from the previous reception timing to the present from the controller 3 through the transmitting-receiving unit 21 and the log management unit 22 (step S11) and writes it to the used bandwidth storing unit 24 (step S12).

Then, the bandwidth management unit 23 reads out the communication amounts of user requests of the day before the previous day and the previous day from the used bandwidth storing unit 24 and calculates the expected communication amount and the expected required bandwidth (step S13) to write them to the used bandwidth storing unit 24 (step S14).

As above, by calculating the expected required bandwidth, the bandwidth management unit 23 may calculate the expected used control bandwidth by using the expected required bandwidth.

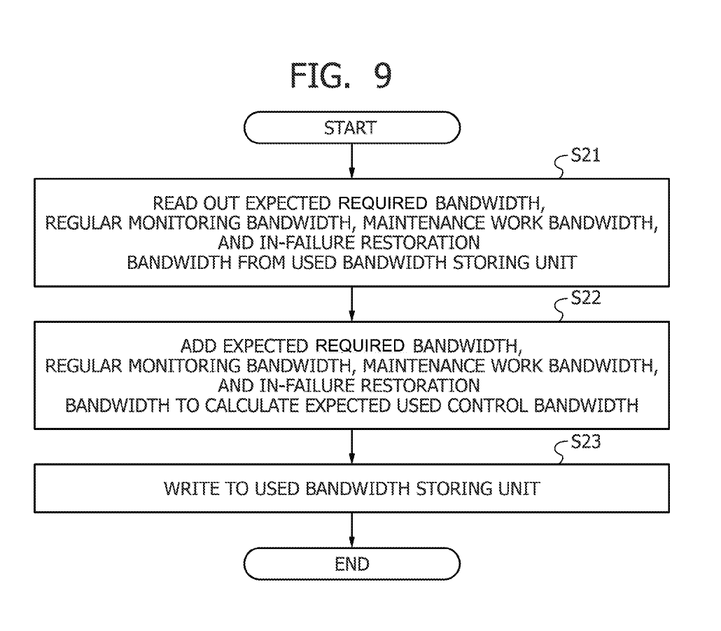

FIG. 9 is a flowchart illustrating a flow of processing of calculating an expected used control bandwidth. As illustrated in FIG. 9, the bandwidth management unit 23 reads out the expected required bandwidth, the regular monitoring bandwidth, the maintenance work bandwidth, and the in-failure restoration bandwidth from the used bandwidth storing unit 24 (step S21). Then, the bandwidth management unit 23 adds the expected required bandwidth, the regular monitoring bandwidth, the maintenance work bandwidth, and the in-failure restoration bandwidth to calculate the expected used control bandwidth (step S22). Then, the bandwidth management unit 23 writes the calculated expected used control bandwidth to the used bandwidth storing unit 24 (step S23).

Because the bandwidth management unit 23 calculates the expected used control bandwidth as above, the scheduling unit 27 may determine whether the sum of the log transfer bandwidth and the expected used control bandwidth is equal to or larger than the bandwidth of the management LAN 4.

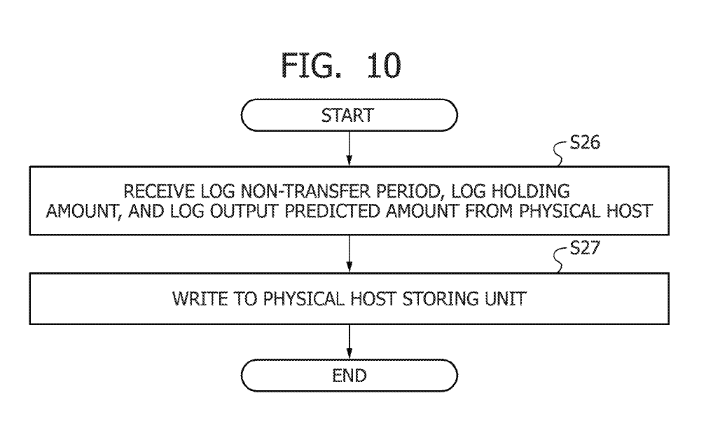

FIG. 10 is a flowchart illustrating a flow of processing of storing a log non-transfer period, a log holding amount, and a log output predicted amount. As illustrated in FIG. 10, the log analyzing unit 25 receives the log non-transfer period, the log holding amount, and the log output predicted amount from the physical host 1 through the transmitting-receiving unit 21 and the log management unit 22 (step S26) to associate the received log non-transfer period, log holding amount, and log output predicted amount with the physical host number and write them to the physical host storing unit 26 (step S27).

Because receiving the log non-transfer period, the log holding amount, and the log output predicted amount from the physical host 1 as above, the log analyzing unit 25 may calculate the log transfer bandwidth.

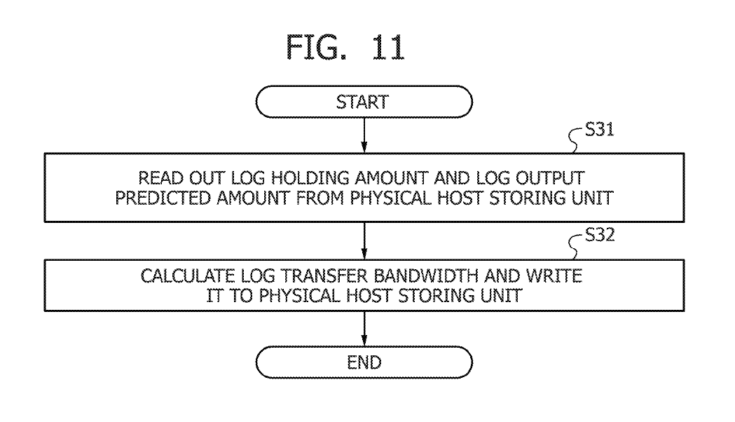

FIG. 11 is a flowchart illustrating a flow of processing of calculating a log transfer bandwidth. As illustrated in FIG. 11, for each physical host 1, the log analyzing unit 25 reads out the log holding amount and the log output predicted amount from the physical host storing unit 26 (step S31) to calculate the log transfer bandwidth and write it to the physical host storing unit 26 (step S32).

Because the log analyzing unit 25 calculates the log transfer bandwidth as above, the scheduling unit 27 may determine whether the sum of the log transfer bandwidth and the expected used control bandwidth is equal to or larger than the bandwidth of the management LAN 4.

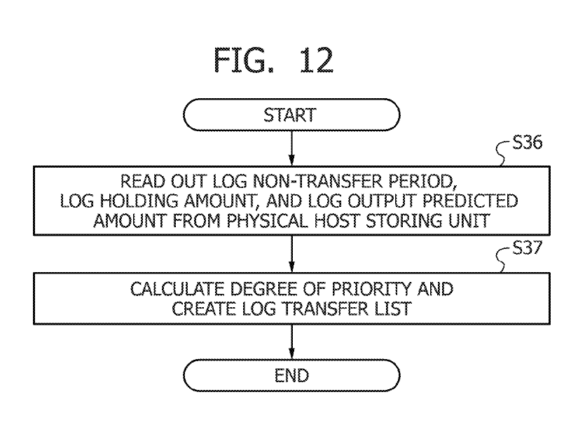

FIG. 12 is a flowchart illustrating a flow of processing of creating a log transfer list. As illustrated in FIG. 12, the scheduling unit 27 reads out the log non-transfer period, the log holding amount, and the log output predicted amount from the physical host storing unit 26 (step S36) to calculate the degree of priority and create the log transfer list (step S37).

Because calculating the degree of priority in log transfer based on the log non-transfer period, the log holding amount, and the log output predicted amount as above, the scheduling unit 27 may identify the physical host 1 with the highest degree of priority.

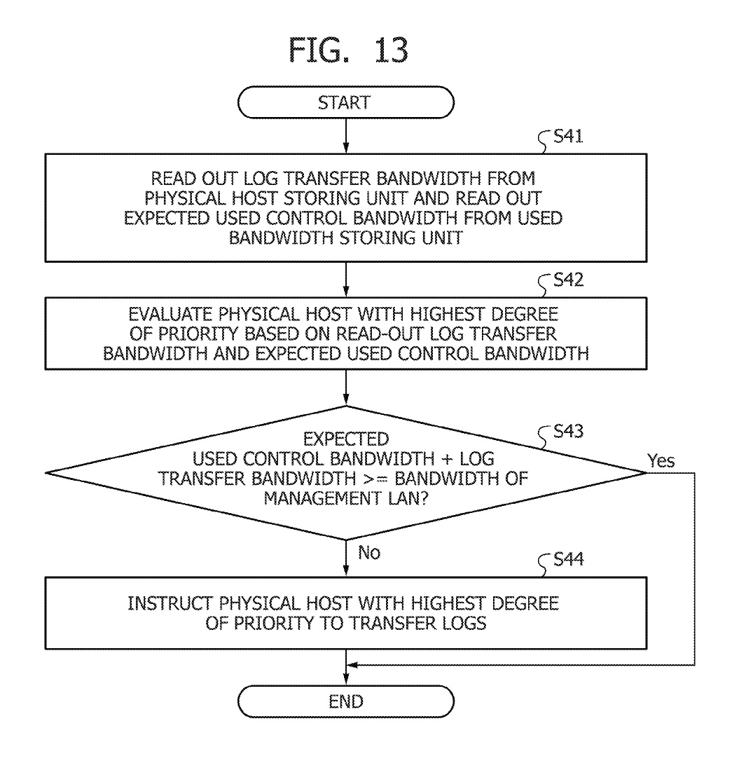

FIG. 13 is a flowchart illustrating a flow of processing of deciding a physical host 1 that is to transfer logs. As illustrated in FIG. 13, the scheduling unit 27 reads out the log transfer bandwidth from the physical host storing unit 26 and reads out the expected used control bandwidth from the used bandwidth storing unit 24 regarding the physical host 1 with the highest degree of priority (step S41).

Then, the scheduling unit 27 evaluates the physical host 1 with the highest degree of priority based on the read-out log transfer bandwidth and expected used control bandwidth (step S42). In particular, the scheduling unit 27 determines whether expected used control bandwidth+log transfer bandwidth is equal to or larger than the bandwidth of the management LAN 4 (step S43), and ends the processing when the sum is equal to or larger than the bandwidth of the management LAN 4.

On the other hand, when expected used control bandwidth+log transfer bandwidth is not equal to or larger than the bandwidth of the management LAN 4, the scheduling unit 27 instructs the physical host 1 with the highest degree of priority to transfer logs (step S44).

The scheduling unit 27 may suppress the occurrence of congestion in the management LAN 4 due to log transfer by making an instruction to transfer logs when expected used control bandwidth+log transfer bandwidth is not equal to or larger than the bandwidth of the management LAN 4 as above.

As described above, in embodiment 1, the bandwidth management unit 23 calculates the expected used control bandwidth and the log analyzing unit 25 calculates the log transfer bandwidth. Then, the scheduling unit 27 calculates the degree of priority of each physical host 1 and determines whether log transfer is possible based on the bandwidth of the management LAN 4, the expected used control bandwidth, and the log transfer bandwidth regarding the physical host 1 with the highest degree of priority. When determining that log transfer is possible, the scheduling unit 27 instructs the physical host 1 with the highest degree of priority to transfer logs. Therefore, the log server 2 may suppress the adverse effect of log transfer on the control of the cloud system.

Furthermore, in embodiment 1, the bandwidth management unit 23 calculates the expected used control bandwidth based on the expected required bandwidth, the regular monitoring bandwidth, the maintenance work bandwidth, and the in-failure restoration bandwidth and therefore may accurately calculate the expected used control bandwidth.

Moreover, in embodiment 1, the bandwidth management unit 23 calculates the expected required bandwidth based on the communication amounts of user requests of the day before the previous day and the previous day and therefore may accurately calculate the expected required bandwidth more accurately than in the case of calculating it based on only the communication amount of the previous day.

### Embodiment 2

Incidentally, in the above-described embodiment 1, whether log transfer is possible is determined only regarding the physical host 1 with the highest degree of priority. However, in some cases, when log transfer of the physical host 1 with the highest degree of priority is not possible, log transfer of another physical host 1 is possible. Thus, in embodiment 2, a description will be made about the log server 2 that instructs another physical host 1 to transfer logs when log transfer of the physical host 1 with the highest degree of priority is not possible.

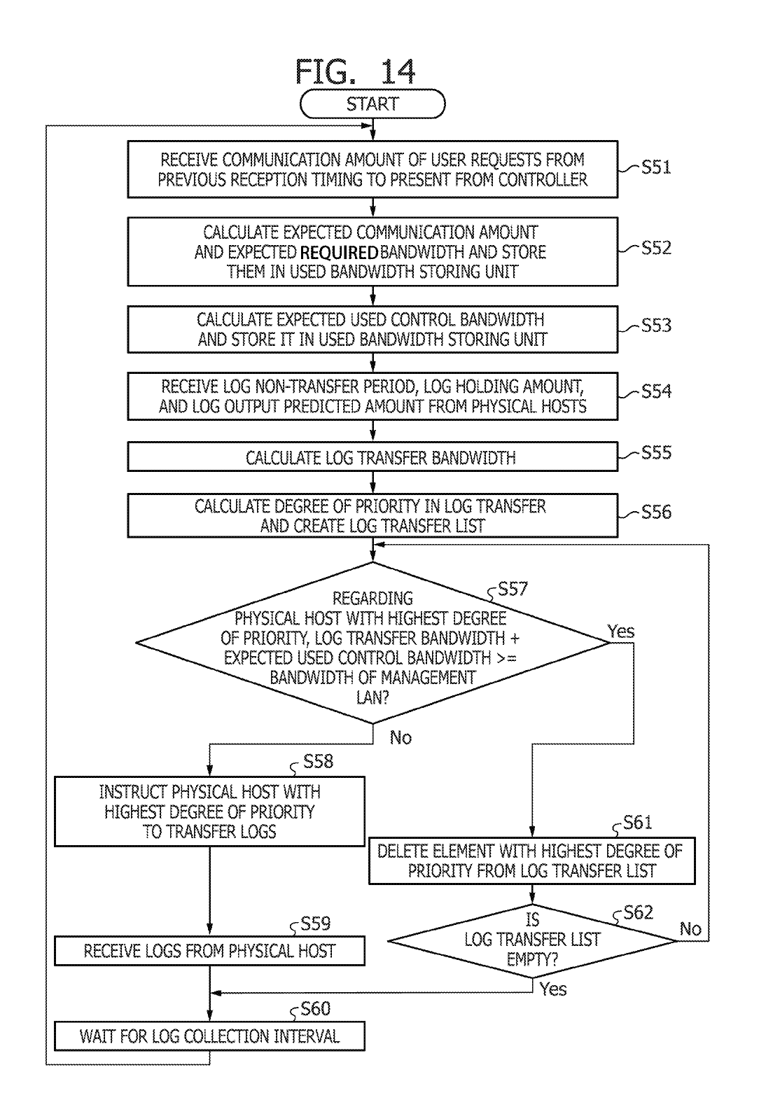

FIG. 14 is a flowchart illustrating a flow of processing by a log server 2 according to embodiment 2. In FIG. 14, processing of steps S51 to S60 is the same as the processing of the step S1 to the step S10 represented in FIG. 7. When log transfer bandwidth+expected used control bandwidth is equal to or larger than the bandwidth of the management LAN 4 in the step S57, the log server 2 according to embodiment 2 deletes the element with the highest degree of priority from the log transfer list (step S61). Then, the log server 2 according to embodiment 2 determines whether the log transfer list is empty (step S62), and moves to the step S60 when the log transfer list is empty. On the other hand, when the log transfer list is not empty, the log server 2 according to embodiment 2 moves to the step S57 and determines whether log transfer is possible regarding the physical host 1 with the next highest degree of priority.

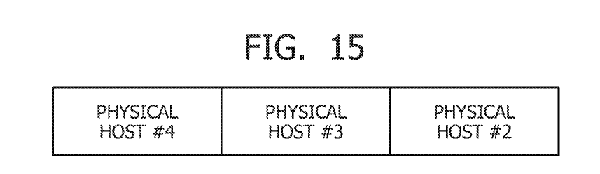

FIG. 15 is a diagram illustrating a log transfer list after a leading element is deleted from a log transfer list illustrated in FIG. 5. As illustrated in FIG. 15, physical host #1 is deleted from the log transfer list and physical host #4 becomes the leading element of the log transfer list. Therefore, when physical host #1 is not allowed to transfer logs, the log server 2 according to embodiment 2 determines whether log transfer is possible regarding physical host #4.

As described above, in embodiment 2, when log transfer of the physical host 1 is not possible, the log server 2 determines whether log transfer of the physical host 1 with the next highest degree of priority is possible, and instructs the physical host 1 with the next highest degree of priority to transfer logs when log transfer is possible. Therefore, the log server 2 may efficiently use the bandwidth of the management LAN 4.

### Embodiment 3

In embodiment 1 and embodiment 2, the case in which one physical host 1 transfers logs in one time of log collection is described. However, plural physical hosts 1 may transfer logs in one time of log collection. Thus, in embodiment 3, a description will be made about the log server 2 that instructs plural physical hosts 1 to transfer logs in one time of log collection.

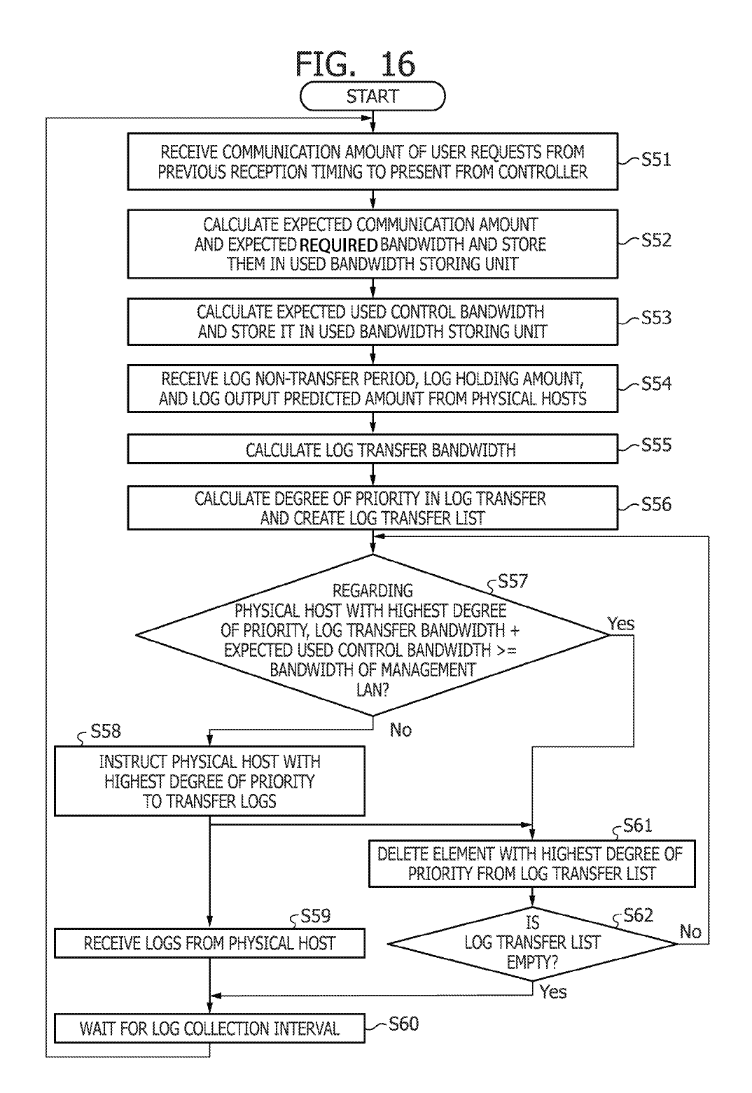

FIG. 16 is a flowchart illustrating a flow of processing by a log server 2 according to embodiment 3. When FIG. 16 is compared with FIG. 14, a flow from the step S58 to the step S61 is added. When instructing one physical host 1 to transfer logs, the log server 2 according to embodiment 3 repeats the processing of instructing the physical host 1 about which log transfer is possible in the log transfer list to transfer logs until the log transfer list becomes empty, in parallel with the processing of receiving logs from the physical host 1. Therefore, the log server 2 according to embodiment 3 may instruct plural physical hosts 1 to transfer logs in one time of log collection.

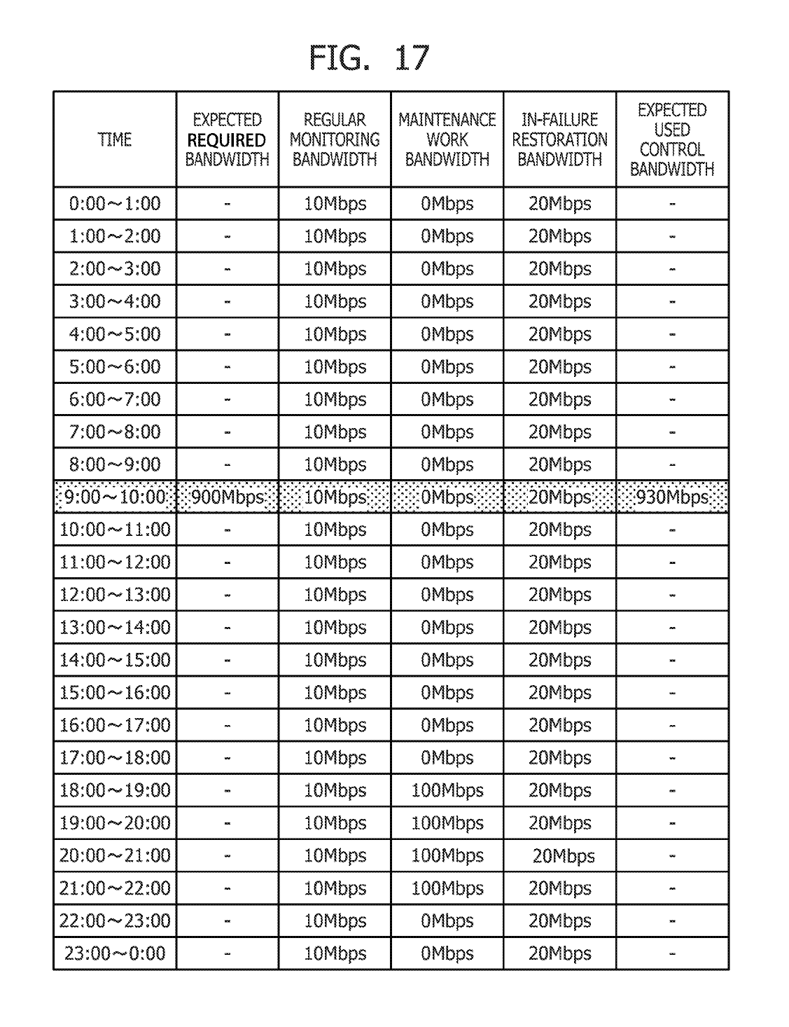

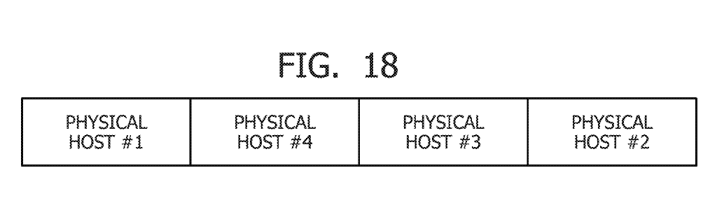

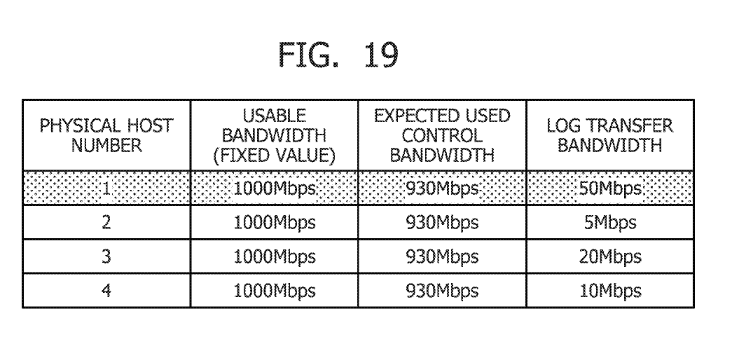

FIG. 17 is a diagram illustrating an example of a used bandwidth storing unit 24. FIG. 18 is a diagram illustrating an example of a log transfer list. FIG. 19 is a diagram illustrating an example of bandwidth information between each physical host 1 and a log server 2. In FIG. 17, the communication amount of the day before the previous day, the communication amount of the previous day, the communication amount of the current day, and the expected communication amount are omitted.

As illustrated in FIG. 17, at 9:00, the expected used control bandwidth is 930 Mbps. Furthermore, as illustrated in FIG. 18, the physical host 1 with the highest degree of priority is physical host #1. Moreover, as illustrated in FIG. 19, regarding physical host #1, the sum of the expected used control bandwidth and the log transfer bandwidth is 980 Mbps and is smaller than the usable bandwidth 1000 Mbps of the management LAN 4. Therefore, the log server 2 according to embodiment 3 instructs physical host #1 to transfer logs.

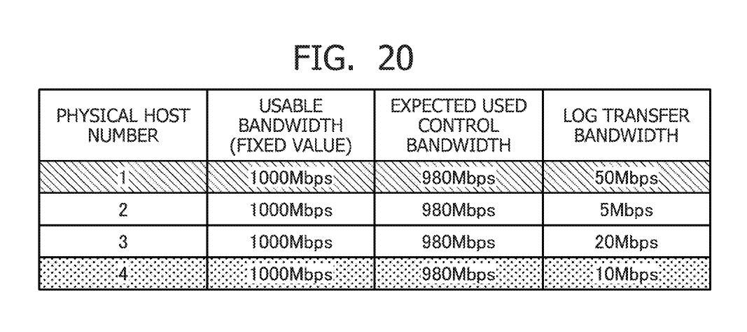

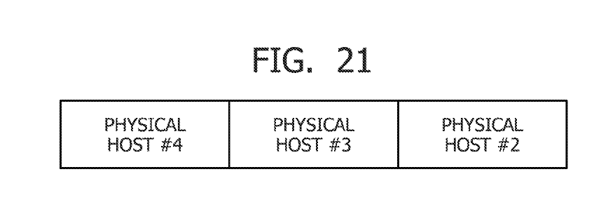

FIG. 20 is a diagram illustrating bandwidth information between each physical host 1 and a log server 2 after a used bandwidth when a physical host #1 transfers logs is added. In FIG. 20, the used bandwidth when physical host #1 transfers logs has been added to the expected used control bandwidth. Furthermore, FIG. 21 is a diagram illustrating a log transfer list after a leading element is deleted from a log transfer list illustrated in FIG. 18.

As illustrated in FIG. 21, the physical host 1 with the next highest degree of priority is physical host #4. Furthermore, as illustrated in FIG. 20, the log transfer bandwidth of physical host #4 is 10 Mbps. Thus, even when this log transfer bandwidth is added to 980 Mbps as the expected used control bandwidth, the sum is smaller than the usable bandwidth 1000 Mbps of the management LAN 4. Therefore, the log server 2 according to embodiment 3 instructs physical host #4 to transfer logs.

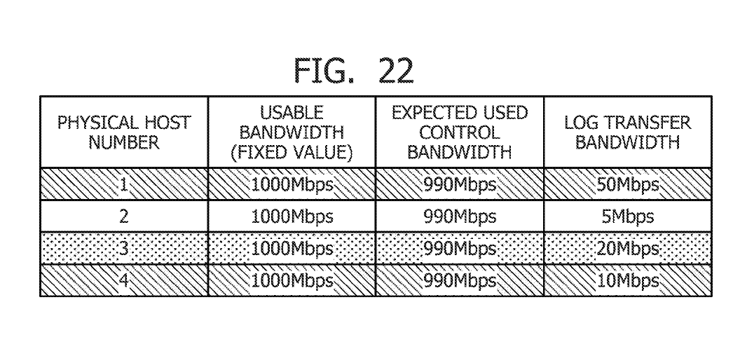

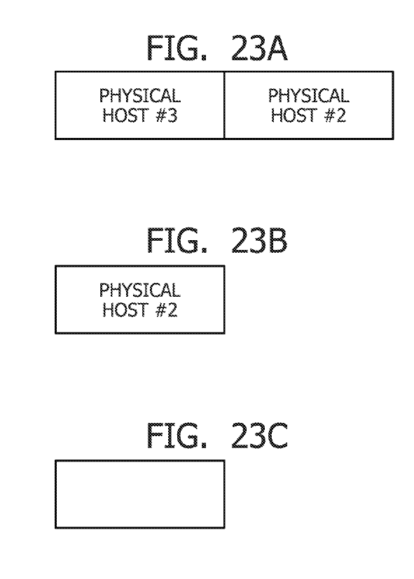

FIG. 22 is a diagram illustrating bandwidth information between each physical host 1 and the log server 2 after a used bandwidth when a physical host #4 transfers logs is added. In FIG. 22, the used bandwidth when physical host #4 transfers logs has been added to the expected used control bandwidth. Furthermore, FIGS. 23A to 23C depict diagrams illustrating a log transfer list after a leading element is sequentially deleted from a log transfer list illustrated in FIG. 21.

As illustrated in FIG. 23A, the physical host 1 with the next highest degree of priority is physical host #3. Furthermore, as illustrated in FIG. 22, the log transfer bandwidth of physical host #3 is 20 Mbps. Thus, the value obtained by adding the log transfer bandwidth of physical host #3 to 990 Mbps as the expected used control bandwidth is larger than the usable bandwidth 1000 Mbps of the management LAN 4. Therefore, the log server 2 according to embodiment 3 does not instruct physical host #3 to transfer logs. Then, the log server 2 according to embodiment 3 deletes physical host #3 from the log transfer list. FIG. 23B illustrates the log transfer list after physical host #3 is deleted.

Then, the log server 2 according to embodiment 3 determines that, regarding physical host #2, the resulting bandwidth is smaller than the usable bandwidth 1000 Mbps of the management LAN 4 even when 5 Mbps as the log transfer bandwidth is added to 990 Mbps as the expected used control bandwidth. Therefore, the log server 2 according to embodiment 3 instructs physical host #2 to transfer logs and deletes physical host #2 from the log transfer list. FIG. 23C illustrates the log transfer list after physical host #2 is deleted. As illustrated in FIG. 23C, the log transfer list becomes empty. Therefore, the log server 2 according to embodiment 3 waits for the log collection interval.

As described above, in embodiment 3, the log server 2 may instruct plural physical hosts 1 to transfer logs in one time of log collection and efficiently use the bandwidth of the management LAN 4.

With FIG. 2, the functional configuration of the log server 2 is described. The functions of the log server 2 are implemented through execution of a program in the log server 2. Thus, the hardware configuration of the log server 2 that executes the program will be described.

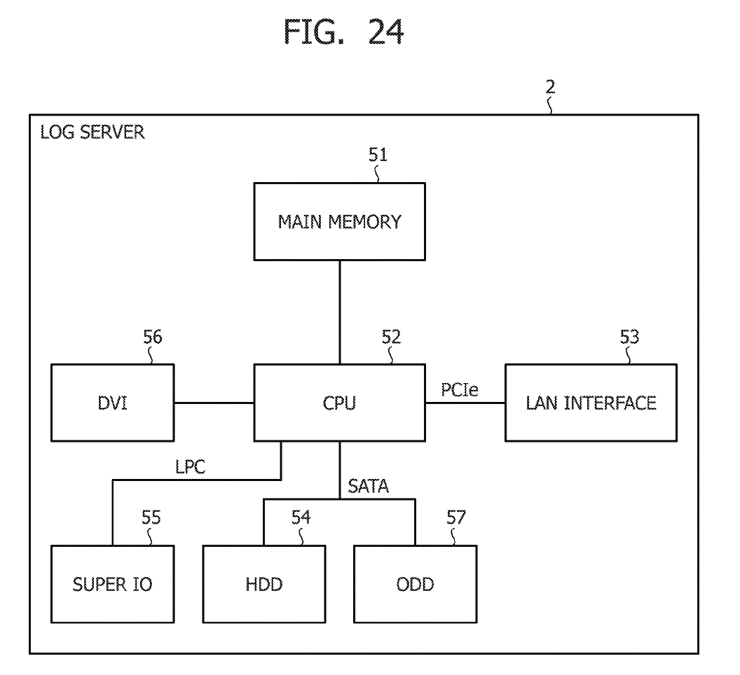

FIG. 24 is a diagram illustrating a hardware configuration of a log server 2 that executes a program according to an embodiment. As illustrated in FIG. 24, the log server 2 includes a main memory 51, a central processing unit (CPU) 52, a LAN interface 53, and a hard disk drive (HDD) 54. Furthermore, the log server 2 includes a super input/output (IO) 55, a digital visual interface (DVI) 56, and an optical disk drive (ODD) 57.

The main memory 51 is a memory that stores a program, a halfway result of execution of a program, and so forth. The CPU 52 is a central processing apparatus that reads out a program from the main memory 51 and executes the program. The CPU 52 includes a chipset having a memory controller.

The LAN interface 53 is an interface for coupling the log server 2 to another computer via a LAN. The HDD 54 is a disk apparatus that stores programs and data and the super IO 55 is an interface for coupling input apparatuses such as mouse and keyboard. The DVI 56 is an interface that couples a liquid display apparatus and the ODD 57 is an apparatus that carries out reading and writing of a digital versatile disc (DVD).

The LAN interface 53 is coupled to the CPU 52 based on the peripheral component interconnect express (PCIe) and the HDD 54 and the ODD 57 are coupled to the CPU 52 based on the serial advanced technology attachment (SATA). The super IO 55 is coupled to the CPU 52 based on the low pin count (LPC).

Furthermore, the program executed in the log server 2 is stored in a DVD, which is one example of a recording medium readable by the log server 2, and is read out from the DVD by the ODD 57 to be installed on the log server 2. Alternatively, the program is stored in a database or the like of another computer system coupled via the LAN interface 53 and is read out from this database to be installed on the log server 2. Then, the installed program is stored in the HDD 54 and is read out into the main memory 51 to be executed by the CPU 52.

In the embodiments, the bandwidth management unit 23 calculates the expected required bandwidth based on the communication amounts of user requests of the day before the previous day and the previous day. However, the expected required bandwidth may be calculated by using another communication amount such as the communication amount of user requests made three days ago.

Furthermore, in the embodiments, the case of carrying out log collection in a cloud system is described. However, the log server 2 may carry out log collection in another information processing system.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and the processor configured to:
determine whether a first physical host of a plurality of physical hosts is able to transmit logs based on a first bandwidth of a management local area network via which the plurality of physical hosts transmit logs, a second bandwidth of the management local area network used when the first physical host transmits logs, and a third bandwidth of the management local area network used when a controller controls an information processing system including the plurality of physical hosts; and
transmit, to the first physical host, an instruction to transmit logs when it is determined that the first physical host is able to transmit logs.

2. The information processing apparatus according to claim 1, wherein
the processor is further configured to:
determine whether respective physical hosts of the plurality of physical hosts are able to transmit logs based on the first bandwidth, bandwidths of the management local area network used when the respective physical hosts transmit logs, and the third bandwidth; and
transmit, to at least one of physical hosts that is determined to be able to transmit logs, an instruction to transmit logs.

3. The information processing apparatus according to claim 1, wherein
the processor is further configured to:
manage degrees of priority of the plurality of physical hosts in log transfer;
determine, when it is determined that the first physical host is not able to transmit logs, whether a second physical host of the plurality of physical hosts is able to transmit logs based on a fourth bandwidth of the management local area network used when the second physical host transmits logs, wherein a degree of priority of the second physical host in log transfer is lower than a degree of priority of the first physical host in log transfer; and
transmit, to the second physical host, an instruction to transmit logs when it is determined that the second physical host is able to transmit logs.

4. The information processing apparatus according to claim 1, wherein
the processor is further configured to:
calculate the third bandwidth based on a bandwidth of the management local area network used in processing executed by the controller during maintenance or fault recovery and a fifth bandwidth of the management local area network used in processing executed by the controller outside of the maintenance and the fault recovery.

5. The information processing apparatus according to claim 4, wherein
the processor is further configured to:
calculate the fifth bandwidth based on a sixth bandwidth of the management local area network used in processing that occurs due to user requests, a bandwidth of the management local area network used in processing that occurs in maintenance work of the information processing system, and a bandwidth of the management local area network used in restoration processing at time of failure of the information processing system.

6. The information processing apparatus according to claim 5, wherein
the processor is further configured to:
predict the sixth bandwidth based on a communication amount of past user requests.

7. An information processing method comprising:
determining, by a computer, whether a first physical host of a plurality of physical hosts is able to transmit logs based on a first bandwidth of a management local area network via which the plurality of physical hosts transmit logs, a second bandwidth of the management local area network used when the first physical host transmits logs, and a third bandwidth of the management local area network used when a controller controls an information processing system including the plurality of physical hosts; and
transmitting, to the first physical host, an instruction to transmit logs when it is determined that the first physical host is able to transmit logs.

8. A non-transitory computer-readable recording medium having stored therein a program that causes a computer to execute a process, the process comprising:
determining whether a first physical host of a plurality of physical hosts is able to transmit logs based on a first bandwidth of a management local area network via which the plurality of physical hosts transmit logs, a second bandwidth of the management local area network used when the first physical host transmits logs, and a third bandwidth of the management local area network used when a controller controls an information processing system including the plurality of physical hosts; and
transmitting, to the first physical host, an instruction to transmit logs when it is determined that the first physical host is able to transmit logs.
